(19) United States
(12) Patent Application Publication
(10) Pub. No.: US 2026/0314620 A1
(43) Pub. Date: Oct. 15, 2026

(54) DEMINERALISED VITAMIN-REDUCED LACTOSE CONCENTRATE

(71) Applicant: N.V. Nutricia, Zoetermeer (NL)

(72) Inventors: Cameron Hugh Marshall, Utrecht (NL); Ana Maria Ospina Martinez, Utrecht (NL); Elisabete Carina Pinto Machado, Utrecht (NL)

(73) Assignee: N.V. Nutricia, Zoetermeer (NL)

(21) Appl. No.: 19/553,529

(22) Filed: Mar. 2, 2026

Related U.S. Application Data
(63) Continuation of application No. PCT/EP2024/075030, filed on Sep. 6, 2024.

(30) Foreign Application Priority Data
Sep. 8, 2023 (EP) 23196348.9

(51) Int. Cl. A23C 9/146; A23L 33/00

(52) U.S. Cl. CPC A23C 9/1465; A23L 33/40; A23C 2210/206

(57) ABSTRACT

The present invention relates to a process of producing a demineralised vitamin-reduced lactose concentrate, said process comprising the step of contacting a partially demineralised aqueous lactose isolate with an ion-exchange resin. The present invention further relates to a demineralised vitamin-reduced lactose concentrate.

### TECHNICAL FIELD OF THE INVENTION

The present invention relates to a process of producing a demineralised vitamin-reduced lactose concentrate, said process comprising the step of contacting a partially demineralised aqueous lactose isolate with an ion-exchange resin. The present invention further relates to a demineralised vitamin-reduced lactose concentrate.

### BACKGROUND OF THE INVENTION

Infant formula is a manufactured food designed and marketed for feeding to babies and infants under 12 months of age, usually prepared for bottle-feeding or cup-feeding from powder (mixed with water) or liquid (with or without additional water).

The composition of infant formula is designed to resemble the composition of human milk at approximately one to three months postpartum. The most commonly used infant formulas contain purified cow's milk whey and casein as a protein source, a blend of vegetable oils as a fat source, lactose as a carbohydrate source, a vitamin-mineral mix, and other ingredients depending on the manufacturer.

Although cow's milk is the basis of almost all infant formula, plain cow's milk is unsuited for infants because of its high casein content and low whey content. The infant intestine is not properly equipped to digest non-human milk, and this may result in diarrhea, intestinal bleeding and/or malnutrition. To reduce the negative effect on the infant's digestive system, cow's milk is processed to make it suitable for use in infant formula. This includes steps to alter the whey-to-casein protein balance, the addition of several essential ingredients (often called “fortification”, see below), the partial or total replacement of dairy fat with fats of vegetable or marine origin, etc.

Carbohydrates are an important source of energy for growing infants, as they account for 35 to 42 en. % of their daily energy intake. In most cow's milk-based formulas, lactose is the main source of carbohydrates present. Lactose is not only a good source of energy, it also aids in the absorption of the minerals magnesium, calcium, zinc and iron.

Infant formulae have to meet compositional requirements that are laid down in regulations such as the European Commission Directive 2006/141/EC of 22 Dec. 2006 on infant formulae and follow-on formulae. According to the latter directive, infant formulae should meet, amongst other things, the following compositional requirements (when manufactured from cow's milk proteins):

| | |
|---|---|
| Energy | 250-295 kJ/100 ml |
| Protein | 0.45-0.7 g per 100 kJ |
| Lipids | 1.05-1.4 g per 100 kJ |
| Carbohydrates | 2.2-3.4 g per 100 kJ |
| Lactose | ≥1.1 g per 100 kJ |
| Choline | 1.7-12 mg per100 kJ |
| Vitamin B5 | 95-475 μg per 100 kJ |
| Vitamin B7 | 0.4-1.8 μg per 100 kJ |
| Sodium | 5-14 mg per 100 kJ |
| Potassium | 15-38 mg per 100 kJ |
| Chloride | 12-38 mg per 100 kJ |
| Magnesium | 1.2-3.6 mg per 100 kJ |
| Calcium | 12-33 mg per 100 kJ |

In order to meet these stringent requirements manufacturers of infant formulae prefer to employ sources of proteins, lipids and carbohydrates that are highly purified, i.e. that have a low mineral content and a low content of e.g. vitamin B5, vitamin B7 and carnitine.

The concentration levels of minerals, vitamin B5 and vitamin B7 in cow's milk are quite high and these components are concentrated together with lactose by the membrane filtration step(s) that are commonly applied to prepare lactose concentrates from skimmed milk or whey. It is known to produce a demineralised whey concentrate with high lactose content by subjecting whey to nanofiltration (NF), followed by partial demineralisation of the NF-permeate by means of electrodialysis (ED) and further demineralisation by passing the partially demineralised ED diluate through a column filled with an ion exchange resin.

Demineralised whey concentrates with a high lactose content, which are particularly suited for use in infant formula, are commercially available. For example, Deminal® 90 Liquid (ex FrieslandCampina Ingredients) is such a demineralised whey concentrate. It is sold in liquid and powder form. The liquid product has a dry matter content of 28 wt. %, contains 13.5% protein (N×6.38) and 84.5% lactose, calculated by weight of dry matter. Vitamin B7 content of the product is 4 μg per 100 grams of dry matter and the vitamin B5 content of the product is 4 mg per 100 grams of dry matter.

WO 2022/144447 describes a process of producing a lactose concentrate, said process comprising the step of subjecting a partially demineralised aqueous lactose isolate to electrodialysis to produce a biotin-reduced lactose isolate containing at least 90% lactose by weight of dry matter and less than 2 mg ash per gram of lactose, and containing:
0.02-1.5 mg sodium per gram of lactose;
0.02-2 mg potassium per gram of lactose;
0.05-1.5 mg chloride per gram of lactose;
0.01-0.25 μg biotin per gram of lactose.

WO 2022/200531 describes a method for treating a milk protein composition in order to obtain a lactose-rich liquid composition, comprising a step of ultrafiltration in order to obtain an ultrafiltration permeate and an ultrafiltration retentate; followed by a step of treatment on ion exchange resins comprising at least one pass comprising percolation on a cationic resin followed by percolation on an anionic resin.

### SUMMARY OF THE INVENTION

The inventors have designed a novel process that enables the preparation of a highly demineralised lactose concentrate and also a reduced vitamin B5 and vitamin B7 content. The inventors have found that the vitamins B5 and B7 can be removed very effectively from a partially demineralised aqueous lactose solution by subjecting said solution to an anion exchange resin.

Accordingly, the present invention provides a process of producing a demineralised vitamin-reduced lactose concentrate, said method comprising:
providing a partially demineralised aqueous lactose isolate containing at least 96 wt. % lactose by weight of dry matter and a water content of 60-95 wt. % by weight of said isolate, wherein said isolate has a conductivity of less than 600 μS/cm and further contains:
   20-300 μg sodium per gram of lactose;
   40-1000 μg potassium per gram of lactose;
   1-400 μg chloride per gram of lactose;
   1-300 μg magnesium per gram of lactose;
   5-40 μg vitamin B5 per gram of lactose;
   5-55 ng vitamin B7 per gram of lactose;
contacting the partially demineralised aqueous lactose isolate with an anion exchange resin to produce a demineralised vitamin-reduced lactose concentrate containing at least 97 wt. % lactose by weight of dry matter, and further containing:
   0.1-40 μg sodium per gram of lactose;
   0.1-40 μg potassium per gram of lactose;
   0-20 μg chloride per gram of lactose;
   0-20 μg magnesium per gram of lactose;
   0.1-20 μg vitamin B5 per gram of lactose;
   0.1-30 ng vitamin B7 per gram of lactose;
      wherein the vitamin B5 content of the demineralised vitamin-reduced lactose concentrate calculated by weight of lactose is at least 50% lower than the vitamin B5 content of the partially demineralised lactose isolate calculated by weight of lactose.

The above process of the invention is effectively a process to reduce the vitamin B5 content in a lactose concentrate. In addition, the inventors have found that this process effectively reduces the amount of vitamin B7 and carnitine.

The present invention further relates to a demineralised vitamin-reduced lactose concentrate, said concentrate comprising:
at least 980 mg lactose per gram of dry matter;
0.1-40 μg sodium per gram of lactose;
0.1-40 μg potassium per gram of lactose;
0-20 μg chloride per gram of lactose;
0-20 μg magnesium per gram of lactose;
0.1-40 μg calcium per gram of lactose;
0.1-20 μg vitamin B5 per gram of lactose;
0.1-30 ng vitamin B7 per gram of lactose;
0.1-50 μg L-carnitine per gram of lactose;
0.1-5 mg choline per gram of lactose.

### DETAILED DESCRIPTION OF THE INVENTION

A first aspect of the present invention relates to a process of producing a demineralised vitamin-reduced lactose concentrate, said method comprising:
providing a partially demineralised aqueous lactose isolate containing at least 96 wt. % lactose by weight of dry matter and a water content of 60-95 wt. % by weight of said isolate, wherein said isolate has a conductivity of less than 600 μS/cm and further contains:
   20-300 μg sodium per gram of lactose;
   40-1000 μg potassium per gram of lactose;
   1-400 μg chloride per gram of lactose;
   1-300 μg magnesium per gram of lactose;
   5-40 μg vitamin B5 per gram of lactose;
   5-55 ng vitamin B7 per gram of lactose;
contacting the partially demineralised aqueous lactose isolate with an anion exchange resin to produce a demineralised vitamin-reduced lactose concentrate containing at least 97 wt. % lactose by weight of dry matter, and further containing:
   0.1-40 μg sodium per gram of lactose;
   0.1-40 μg potassium per gram of lactose;
   0-20 μg chloride per gram of lactose;
   0-20 μg magnesium per gram of lactose;
   0.1-20 μg vitamin B5 per gram of lactose;
   0.1-30 ng vitamin B7 per gram of lactose;
      wherein the vitamin B5 content of the demineralised vitamin-reduced lactose concentrate calculated by weight of lactose is at least 50% lower than the vitamin B5 content of the partially demineralised lactose isolate calculated by weight of lactose.

The term “vitamin B5” as used herein refers to a water-soluble B-vitamin (pantothenic acid) with the following IUPAC name: 3-[(2R)-2,4-Dihydroxy-3,3-dimethylbutanamido]propanoic acid and the CAS number 599-54-2.

The term “vitamin B7” as used herein refers to a water-soluble B-vitamin (biotin) with the following IUPAC name: 5-[(3aS,4S,6aR)-2-oxohexahydro-1H-thieno[3,4-d]imidazol-4-yl]pentanoic acid and the CAS number 58-85-5.

The term “ion exchange resin” as used herein refers to materials that facilitate ion exchange reactions. They are composed of polymeric hydrocarbon matrices to which ionic “functional groups” of either positively-charged (cationic) functional groups or negatively-charged (anionic) functional groups are permanently bound. These functional groups have a net negative or positive charge that allows them to readily attract ions of an opposing charge.

The term “anion exchange resin” refers to a polymeric hydrocarbon matrix to which cationic base functional groups are permanently bound. These cationic base functional groups facilitate the exchange of negatively charged ions (anions).

The term “cation exchange resin” refers to a polymeric hydrocarbon matrix to which anionic acid functional groups are permanently bound. These anionic acid functional groups facilitate the exchange of positively charged ions (cations).

The term “ash” as used herein refers to the inorganic residue remaining after either ignition or complete oxidation of organic matter in a sample. The inorganic residue consists mainly of minerals.

The term “dairy” as used herein refers to products derived from cow's milk, goat's milk, sheep's milk, horse's milk and buffalo's milk.

The term “infant formula” as used herein refers to a foodstuff intended for nutritional use by infants during the first 12 months of life. The term “infant formula” encompasses both “starter infant formula” and “follow-up formula” or “follow-on formula”. Preferably, the infant formula meets the requirement of the European Commission Directive 2006/141/EC of 22 Dec. 2006 on infant formulae and follow-on formulae.

### Partially Demineralised Aqueous Lactose Isolate

The partially demineralised aqueous lactose isolate that is processed in the present process preferably is dairy derived, more preferably it is cow's milk derived.

The water content of the partially demineralised aqueous lactose isolate is 60-95 wt. %, preferably 65-90 wt. %, more preferably 70-85 wt. %, by weight of the partially demineralised aqueous lactose isolate.

The dry matter content of the partially demineralised aqueous lactose isolate is preferably 5-40 wt. %, more preferably 10-35 wt. % and most preferably 15-30 wt. % by weight of said isolate.

Lactose and water together preferably constitute at least 90 wt. %, more preferably at least 95 wt. % of the partially demineralised aqueous lactose isolate.

The lactose content of the partially demineralised aqueous lactose isolate is at least 96 wt. %, more preferably 96.5-99 wt. %, most preferably 97-98 wt. % lactose by weight of dry matter.

The partially demineralized aqueous lactose isolate preferably has a conductivity of below 450 μS/cm, preferably below 300 μS/cm, more preferably between 50-150 μS/cm.

The partially demineralised aqueous lactose isolate preferably contains 30-250 μg sodium per gram of lactose, more preferably 40-200 μg sodium per gram of lactose.

Potassium is preferably contained in the partially demineralised aqueous lactose isolate in a concentration of 50-600 μg potassium per gram of lactose, more preferably in a concentration of 60-200 μg potassium per gram of lactose.

The chloride content of the partially demineralised aqueous lactose isolate preferably lies in the range of 4-200 μg chloride per gram of lactose, more preferably in the range of 8-100 μg chloride per gram of lactose.

The magnesium content of the partially demineralised aqueous lactose isolate preferably lies in the range of 10-200 μg magnesium per gram of lactose, more preferably in the range of 20-100 μg magnesium per gram of lactose.

The calcium content of the partially demineralised aqueous lactose isolate preferably lies in the range of 40-1200 μg calcium per gram of lactose, more preferably in the range of 50-600 μg calcium per gram of lactose.

The partially demineralised aqueous lactose isolate preferably contains at most 20 mg ash per gram of lactose, more preferably at most 10 mg ash per gram of lactose and most preferably 0.1-5 mg ash per gram of lactose.

Vitamin B5 is preferably contained in the partially demineralised aqueous lactose isolate in a concentration of 7-35 μg vitamin B5 per gram of lactose, more preferably in a concentration of 10-30 μg vitamin B5 per gram of lactose.

Vitamin B7 is preferably contained in the partially demineralised aqueous lactose isolate in a concentration of 6-40 ng vitamin B7 per gram of lactose, more preferably in a concentration of 7-20 ng vitamin B7 per gram of lactose.

The L-carnitine content of the partially demineralised aqueous lactose isolate preferably lies in the range of 100-650 μg L-carnitine per gram of lactose, more preferably in the range of 200-450 μg L-carnitine per gram of lactose.

The choline content of the partially demineralised aqueous lactose isolate preferably lies in the range of 0.1-5 μg choline per gram of lactose, more preferably in the range of 0.5-2.5 μg choline per gram of lactose.

Preferably, the partially demineralised aqueous lactose isolate contains less than 3 wt. %, more preferably less than 2 wt. % and most preferably contains 0-1 wt. % protein by weight of dry matter.

The fat content of the partially demineralised aqueous lactose isolate is preferably less than 3 wt. %, more preferably less than 2 wt. %, and most preferably is 0-1 wt. % fat by weight of dry matter.

The pH of the partially demineralised aqueous lactose isolate is preferably in the range of 4 to 7.5, most preferably in the range of 4.5 to 7.

In a preferred embodiment, the present process comprises preparing the partially demineralised aqueous lactose isolate by:
subjecting a dairy liquid to an ultrafiltration step to produce a ultrafiltration permeate;
subjecting the ultrafiltration permeate to a nanofiltration or reverse osmosis step to produce a nanofiltration or reverse osmosis retentate; and
subjecting the nanofiltration or reverse osmosis retentate to an electrodialysis step.

The dairy liquid is preferably selected from whole milk, skimmed milk, acid whey, sweet whey and combinations thereof. More preferably, the dairy liquid is whole milk or skimmed milk, most preferably skimmed milk.

Preferably the dairy liquid is a microfiltered dairy liquid, wherein the microfiltered dairy liquid is produced by microfiltration with a membrane having a pore size of 0.05-0.3 μm, more preferably a pore size of 0.1-0.2 μm.

Preferably the ultrafiltration step employs an ultrafiltration membrane having a cut-off in the range of 3-100 kDa, more preferably in the range of 5-20 kDa.

Preferably the nanofiltration or reverse osmosis step employs an nanofiltration or reverse osmosis membrane having a cut-off in the range of 20-3000 Da, more preferably in the range of 500-2000 Da and most preferably in the range of 800-1000 Da.

Preferably, the nanofiltration or reverse osmosis retentate is subjected to a softening step before being subjected to the electrodialysis step, said softening step comprising adding a sequestering agent to the nanofiltration or reverse osmosis retentate, said sequestering agent being selected from phosphates, polyphosphates, phosphonates, polycarboxylates and combinations thereof. Calcium phosphate may be suitably removed from the aforementioned retentate by precipitating the calcium phosphate, followed by a solid-liquid separation (e.g. filtration or centrifugation). Precipitation of calcium phosphate is preferably induced by ensuring that the pH of retentate is in the range of 5.5 to 9.0, more preferably in the range of 6.5 to 8.5 while it is heated to above 60° C. for more than 30 minutes.

The electrodialysis step of the present process is preferably carried out using a voltage in the range of 30 to 200 V, more preferably in the range of 30 to 100 V and most preferably of 30 to 50 V. Herein the voltage refers to the voltage that is applied across the ion selective membranes while the nanofiltration or reverse osmosis retentate flows past these membranes.

Preferably, the total electrical energy input during the electrodialysis step equals 20-200 Joule per gram of lactose, more preferably 30-180 Joule per gram of lactose, most preferably 35-160 Joule per gram of lactose.

The electrodialysis step is preferably carried out at a temperature of 4-65° C., more preferably at a temperature of 6-20° C. and most preferably at a temperature of 8-15° C.

The pressure employed during the electrodialysis step is preferably in the range of 0.5-3 bar.

### Ion Exchange Resin (IEX) Step

In the present process the partially demineralised aqueous lactose isolate is contacted with an anion exchange resin to reduce the amount of vitamin B5, vitamin B7 and carnitine.

Preferably, the temperature during the ion exchange treatment is controlled between 5-30° C., more preferably between 8-25° C. and most preferably between 10-20° C.

Preferably, the partially demineralised aqueous lactose isolate is contacted with both an anion exchange resin and a cation exchange resin. By contacting the partially demineralised aqueous lactose isolate with both types of ions exchange resin the purity of lactose is increased. More preferably, the partially demineralised aqueous lactose isolate is first contacted with a cation exchange resin and subsequently with an anion exchange resin. Even more preferably, the partially demineralised aqueous lactose isolate is first contacted with a strong acid cation exchange resin and subsequently with a weak basic anion exchange resin. The (strong acid) cation exchange resin in combination with the (weak basic) anion exchange resin is preferably applied for demineralization and surprisingly also removes vitamin B5, vitamin B7 and carnitine.

The anion exchange resin preferably comprises a matrix of polystyrene or polyacrylate, more preferably the matrix of the anion exchange resin is polyacrylate. Preferably, the anion exchange resin comprises basis functional groups, more preferably weak basic functional groups, even more preferably the basic functional groups are amine groups, and most preferably the basic functional groups are tertiary amine groups. A suitable commercially available anion exchange resin is Applexion™ XA 3112, Applexion.

The cation exchange resin preferably comprises a matrix of polystyrene or crosslinked polystyrene, more preferably the matrix is a styrene divinylbenzene copolymer. Preferably, the cation exchange resin comprises acidic functional groups, more preferably strong acidic functional groups, and most preferably the acidic functional groups are sulfonic acid groups. A suitable commercially available cation exchange resin is Applexion™ XA 2041 in hydrogen form, Applexion.

Preferably, the anion exchange resin and/or cation exchange resin are filled in a column and the partially demineralized aqueous lactose isolate is passed through one or both of these columns. Preferably, the columns filled with ion exchange resin have a diameter in the range of 0.5-5 meter. Preferably, the columns are filled with 30-60 vol. % ion exchange resin by total volume of the column, more preferably 40-50 vol. % ion exchange resin by total volume of the column.

Preferably, the partially demineralized aqueous lactose isolate is passed through the column filled with ion exchange resin with a flow rate of 1-10 resin bed volume equivalents (BV) per hour, more preferably 2-8 BV per hour and most preferably 3-5 BV per hour. The term “resin bed volume equivalent” as used herein is the volume of the ion exchange resin as filled in the column.

Preferably the ion exchange treatment is performed in a continuous process.

### Demineralised Vitamin-Reduced Lactose Concentrate

The demineralised vitamin-reduced lactose concentrate that is produced by the IEX step preferably contains at least 98 wt. % lactose by weight of dry matter, more preferably at least 98.5 wt. % lactose by weight of dry matter, and most preferably 99-99.8 wt. % lactose by weight of dry matter.

Preferably, the demineralised vitamin-reduced lactose concentrate has a conductivity of below 50 μS/cm, more preferably below 25 μS/cm, even more preferably below 12 μS/cm and most preferably between 0.001-8 μS/cm.

The sodium content of the demineralised vitamin-reduced lactose concentrate preferably lies in the range of 0.1-30 μg sodium per gram of lactose, more preferably in the range of 0.2-20 μg sodium per gram of lactose, and most preferably in the range of 0.4-15 μg sodium per gram of lactose.

The potassium content of the demineralised vitamin-reduced lactose concentrate preferably lies in the range of 0.1-30 μg potassium per gram of lactose, more preferably in the range of 0.2-20 μg potassium per gram of lactose, most preferably in the range of 0.4-10 μg potassium per gram of lactose.

The chloride content of the demineralised vitamin-reduced lactose concentrate preferably lies in the range of 0.01-16 μg chloride per gram of lactose, more preferably in the range of 0.1-12 μg chloride per gram of lactose, most preferably in the range of 0.5-8 μg chloride per gram of lactose.

The magnesium content of the demineralised vitamin-reduced lactose concentrate preferably lies in the range of 0.01-16 μg magnesium per gram of lactose, more preferably in the range of 0.1-12 μg magnesium per gram of lactose, most preferably in the range of 0.5-8 μg magnesium per gram of lactose.

The calcium content of the demineralised vitamin-reduced lactose concentrate preferably lies in the range of 0.1-40 μg calcium per gram of lactose, more preferably in the range of 0.2-20 μg calcium per gram of lactose, most preferably in the range of 0.5-10 μg calcium per gram of lactose.

The vitamin B5 content of the demineralised vitamin-reduced lactose concentrate preferably lies in the range of 0.1-15 μg vitamin B5 per gram of lactose, more preferably in the range of 0.2-10 μg vitamin B5 per gram of lactose, most preferably in the range of 0.5-5 μg vitamin B5 per gram of lactose.

The vitamin B5 content of the demineralised vitamin-reduced lactose concentrate, calculated by weight of lactose, is preferably at least 60% lower, more preferably at least 70% lower, most preferably 75-90% lower than the vitamin B5 content of the partially demineralised aqueous lactose isolate, calculated by weight of lactose.

The vitamin B7 content of the demineralised vitamin-reduced lactose concentrate preferably is in the range of 0.1-20 ng vitamin B7 per gram of lactose, more preferably in the range of 0.2-15 ng vitamin B7 per gram of lactose, most preferably in the range of 0.5-10 ng vitamin B7 per gram of lactose.

The vitamin B7 content of the demineralised vitamin-reduced lactose concentrate, calculated by weight of lactose, is preferably at least 20% lower, more preferably at least 30% lower, most preferably 35-60% lower than the vitamin B7 content of the partially demineralised aqueous lactose isolate, calculated by weight of lactose.

The L-carnitine content of the demineralised vitamin-reduced lactose concentrate preferably lies in the range of 0.1-50 μg L-carnitine per gram of lactose, more preferably in the range of 0.2-25 μg L-carnitine per gram of lactose, most preferably in the range of 0.5-10 μg L-carnitine per gram of lactose.

The L-carnitine content of the demineralised vitamin-reduced lactose concentrate, calculated by weight of lactose, is preferably at least 70% lower, more preferably at least 80% lower, most preferably 90-100% lower than the L-carnitine content of the partially demineralised aqueous lactose isolate, calculated by weight of lactose.

The choline content of the demineralised vitamin-reduced lactose concentrate preferably lies in the range of 0.1-5 mg choline per gram of lactose, more preferably in the range of 0.2-3.5 mg choline per gram of lactose, most preferably in the range of 0.5-2.5 mg choline per gram of lactose.

The ash content of the demineralised vitamin-reduced lactose concentrate preferably is less than 100 μg ash per gram of lactose, more preferably less than 50 μg ash per gram of lactose, most preferably 0.1-40 μg ash per gram of lactose.

Preferably, the demineralised vitamin-reduced lactose concentrate is subjected to a drying step to reduce the water content of the concentrate to less than 6 wt. %, preferably to a water content of the concentrate between 0.5-5 wt. %.

Preferably, the optionally dried demineralised vitamin-reduced lactose concentrate is combined with one or more edible ingredients to produce nutritional product comprising 10-60 grams of lactose per 100 g dry matter, more preferably 20-50 grams of lactose per 100 g dry matter. Preferably, the nutritional product is an infant formula or a medical nutrition product.

Another aspect of the invention relates to a demineralised vitamin-reduced lactose concentrate, said concentrate comprising:
At least 980 mg lactose per gram of dry matter;
0.1-40 μg sodium per gram of lactose;
0.1-40 μg potassium per gram of lactose;
0-20 μg chloride per gram of lactose;
0-20 μg magnesium per gram of lactose;
0.1-40 μg calcium per gram of lactose;
0.1-20 μg vitamin B5 per gram of lactose;
0.1-30 ng vitamin B7 per gram of lactose;
0.1-50 μg L-carnitine per gram of lactose;
0.1-5 mg choline per gram of lactose.

Preferably, the demineralised vitamin-reduced lactose concentrate is obtainable by, more preferably obtained by, the process described herein before.

Preferably, the embodiments described herein before for the demineralised vitamin-reduced lactose concentrate in the process of the present invention equally apply to the demineralised vitamin-reduced lactose concentrate according to the invention and vice versa.

The demineralised vitamin-reduced lactose concentrate preferably comprises at least 990 mg lactose per gram of dry matter.

The demineralised vitamin-reduced lactose concentrate of the present invention is preferably isolated from a dairy liquid, more preferably from milk, most preferably from cow's milk.

Preferably, the vitamin B5 content of the demineralised vitamin-reduced lactose concentrate, expressed as μg vitamin B5 per gram of lactose, is at least 50% lower, more preferably at least 60% lower and most preferably 70-100% lower compared to the vitamin B5 content of the milk from which the demineralised vitamin-reduced lactose concentrate is isolated.

Preferably, the vitamin B7 content of the demineralised vitamin-reduced lactose concentrate, expressed as ng vitamin B7 per gram of lactose, is at least 60% lower, more preferably at least 70% lower and most preferably 80-100% lower compared to the vitamin B7 content of the milk from which the demineralised vitamin-reduced lactose concentrate is isolated.

Preferably, the L-carnitine content of the demineralised vitamin-reduced lactose concentrate, expressed as μg L-carnitine per gram of lactose, is at least 70% lower, more preferably at least 80% lower and most preferably 90-100% lower compared to the carnitine content of the milk from which the demineralised vitamin-reduced lactose concentrate is isolated.

As used herein, the terms “comprises”, “comprising,” “includes,” “including,” “has,” “having” or any other variation thereof, are intended to cover a non-exclusive inclusion. For example, a process, method, product or apparatus that comprises a list of elements is not necessarily limited to only those elements, but may include other elements not expressly listed or inherent to such process, method, product or apparatus.

The invention is further illustrated by the following non-limiting examples.

### EXAMPLES

### Example 1

Pasteurized raw bovine milk (Dairygold, Mitchelstown, Cork, Ireland) was subjected to centrifugal separation (skimming) at 50° C. for fat removal. 2000 kg of the skimmed milk so obtained was then subjected to ultrafiltration (UF), using a Model F pilot filtration plant (GEA), equipped with spiral wound polymer membranes (Koch, type 3838 VYV 46 mil) having a molecular weight cut off (MWCO) of 10 kDa. The UF process was carried out at 10° C., resulting in a retentate volume of 500 kg and 1500 kg permeate (UFP).

The UFP was subjected to nanofiltration (NF), using a Model F pilot filtration plant (GEA), equipped with two spiral wound polymer membranes (Suez, type DK3838C30, 7.4 m² per membrane) which is guaranteed to have a minimum rejection of 98% on 2000 ppm MgSO₄ at 25° C. (77° F.) and 110 psi operating pressure. The NF process was carried out at 10° C., 28 bar feed pressure via batch concentration to increase the solids content to above 23%, resulting in 300 kg of retentate (NFR) and 1200 kg permeate (NFP).

35 kg of the NFR was subjected to electrodialysis (ED) via Mega Membrain P1 EDR-Y/50 PLC electrodialysis unit with a maximum feed tank capacity of 100 kg. ED was carried out in batch mode with temperature controlled between 10-20° C. A maximum voltage of 50 V was applied resulting in a total current across the membrane stack decreasing from an initial current of 4.6 A. ED continued until the conductivity of the ED diluate reached a level below 600 μS/cm. A sample from the ED diluate was collected.

1.08 kg of the ED diluate was subjected to ion-exchange (IEX) in a lab unit in batch mode. First the ED diluate was pushed with demineralized water through a 250 ml column filled with 100 ml of a strong acid cation resin (Applexion™ XA 2041 hydrogen form, Applexion), followed by a 250 ml column filled with 100 ml of a weak base anion resin (Applexion™ XA 3112, Applexion), to obtain an IEX diluate. Temperature was controlled at about 14° C. The flow rate was 400 ml/hour (4 bed volumes per hour). The cation resin was regenerated with HCl (5 wt. %) and the anion resin was regenerated with NaOH (4 wt. %). One cycle of IEX and regeneration lasted 5 hours. Four cycles were run and samples of the IEX diluate were collected well before reaching breakthrough for each cycle.

The composition of the ED diluate and the IEX diluate (average of the 4 cycles) are outlined in Table 1.

| | Unit | ED diluate | IEX purified product |
|---|---|---|---|
| pH | | 4.9 | 8.1 |
| Conductivity | μS/cm | 83.4 | 5.5 |
| Dry matter | g/100 g diluate | 20 | 19.3 |
| Lactose | g/100 g dry matter | 96 | 99.1 |
| Sodium | μg/g lactose | 69 | 10 |
| Potassium | μg/g lactose | 80 | 1 |
| Chloride | μg/g lactose | 13 | 6 |
| Magnesium | μg/g lactose | 27 | 0 |
| Calcium | μg/g lactose | 51 | 4 |
| Vitamin B5 | μg/g lactose | 14.7 | <2.6 * |
| Vitamin B7 | ng/g lactose | 9 | <5 * |
| Carnitine | μg/g lactose | 270 | <5 * |
| Choline | mg/g lactose | 1.55 | 1.29 |

* Sample comprised the measured compound in levels below the detection limit of the quantification method. The detection limit is indicated here.

These results show that the IEX treatment reduced the mineral content, the vitamin B5 (−82.6%), vitamin B7 (−45.8%) and carnitine (98.1%) content of the ED diluate. These results also show that the IEX treatment had hardly any effect on the choline content of the ED diluate.

1. A process of producing a demineralised vitamin-reduced lactose concentrate, said method comprising:
providing a partially demineralised aqueous lactose isolate containing at least 96 wt. % lactose by weight of dry matter and a water content of 60-95 wt. % by weight of said isolate, wherein said isolate has a conductivity of less than 600 μS/cm and further contains:
20-300 μg sodium per gram of lactose;
40-1000 μg potassium per gram of lactose;
1-400 μg chloride per gram of lactose;
1-300 μg magnesium per gram of lactose;
5-40 μg vitamin B5 per gram of lactose;
5-55 ng vitamin B7 per gram of lactose;
contacting the partially demineralised aqueous lactose isolate with an anion exchange resin to produce a demineralised vitamin-reduced lactose concentrate containing at least 97 wt. % lactose by weight of dry matter, and further containing:
0.1-40 μg sodium per gram of lactose;
0.1-40 μg potassium per gram of lactose;
0-20 μg chloride per gram of lactose;
0-20 μg magnesium per gram of lactose;
0.1-20 μg vitamin B5 per gram of lactose;
0.1-30 ng vitamin B7 per gram of lactose;
wherein the vitamin B5 content of the demineralised vitamin-reduced lactose concentrate calculated by weight of lactose is at least 50% lower than the vitamin B5 content of the partially demineralised lactose isolate calculated by weight of lactose.

2. The process according to claim 1, wherein the partially demineralised aqueous lactose isolate is contacted with both an anion exchange resin and a cation exchange resin.

3. The process according to claim 1, wherein the partially demineralised aqueous lactose isolate is first contacted with a cation exchange resin and subsequently with an anion exchange resin

4. The process according to claim 1, wherein the anion exchange resin comprises a matrix of polystyrene or polyacrylate and wherein the anion exchange resin comprises weak basic functional groups.

5. The process according to claim 4, wherein the basic functional groups are amine groups.

6. The process according to claim 1, wherein the cation exchange resin comprises a matrix of polystyrene or crosslinked polystyrene, wherein the cation exchange resin comprises strong acidic functional groups.

7. The process according to claim 1, wherein the partially demineralized aqueous lactose isolate contains 40-1200 μg calcium per gram of lactose and the demineralised vitamin-reduced lactose concentrate contains 0.1-40 μg calcium per gram of lactose.

8. The process according to claim 1, wherein the partially demineralized aqueous lactose isolate contains 100-650 μg L-carnitine per gram of lactose and the demineralised vitamin-reduced lactose concentrate contains 0.1-50 μg L-carnitine per gram of lactose.

9. The process according to claim 1, wherein the partially demineralized aqueous lactose isolate contains 0.1-5 mg choline per gram of lactose and the demineralised vitamin-reduced lactose concentrate contains 0.1-5 mg choline per gram of lactose.

10. The process according to claim 1, wherein the process comprises preparing the partially demineralized aqueous lactose isolate by:
subjecting a dairy liquid to an ultrafiltration step to produce a ultrafiltration permeate;
subjecting the ultrafiltration permeate to a nanofiltration or reverse osmosis step to produce a nanofiltration or reverse osmosis retentate; and
subjecting the nanofiltration or reverse osmosis retentate to an electrodialysis step.

11. The process according to claim 1, wherein the demineralised vitamin-reduced lactose concentrate is subjected to a drying step to reduce the water content of the concentrate to less than 6 wt. %.

12. The process according to claim 1, wherein the optionally dried demineralised vitamin-reduced lactose concentrate is combined with one or more edible ingredients to produce nutritional product comprising 10-60 grams of lactose per 100 g dry matter.

13. The process according to claim 12, wherein the nutritional product is an infant formula or a medical nutrition product.

14. A demineralised vitamin-reduced lactose concentrate, said concentrate comprising:
at least 980 mg lactose per gram of dry matter;
0.1-40 μg sodium per gram of lactose;
0.1-40 μg potassium per gram of lactose;
0-20 μg chloride per gram of lactose;
0-20 μg magnesium per gram of lactose;
0.1-40 μg calcium per gram of lactose;
0.1-20 μg vitamin B5 per gram of lactose;
0.1-30 ng vitamin B7 per gram of lactose;
0.1-50 μg L-carnitine per gram of lactose;
0.1-5 mg choline per gram of lactose.

15. The demineralised vitamin-reduced lactose concentrate said concentrate comprising:
At least 980 mg lactose per gram of dry matter;
0.1-40 μg sodium per gram of lactose;
0.1-40 μg potassium per gram of lactose;
0-20 μg chloride per gram of lactose;
0-20 μg magnesium per gram of lactose;
0.1-40 μg calcium per gram of lactose;
0.1-20 μg vitamin B5 per gram of lactose;
0.1-30 ng vitamin B7 per gram of lactose;
0.1-50 μg L-carnitine per gram of lactose;
0.1-5 mg choline per gram of lactose
wherein the concentrate is obtained by the process according to claim 1.
